(19) United States
(12) Patent Application Publication
(10) Pub. No.: US 2025/0026598 A1
(43) Pub. Date: Jan. 23, 2025

(54) FREIGHT REPLACEMENT APPARATUS AND FREIGHT REPLACEMENT METHOD

(71) Applicant: SK on Co., Ltd., Seoul (KR)

(72) Inventors: Jin Won KWON, Daejeon (KR); Young Jae KIM, Daejeon (KR); Jun Ho KIM, Daejeon (KR); Je Hyoung LEE, Daejeon (KR)

(21) Appl. No.: 18/769,398

(22) Filed: Jul. 11, 2024

(30) Foreign Application Priority Data
Jul. 19, 2023 (KR) 10-2023-0093960

(51) Int. Cl. B65H 19/12; B65H 19/30

(52) U.S. Cl. CPC B65H 19/126; B65H 19/30

(57) ABSTRACT

Proposed are a freight replacement apparatus and a freight replacement method. According to an embodiment of the present disclosure, the freight replacement apparatus includes an automated loading part configured to load thereon a first freight and to move to a designated position, a transporting part configured to load thereon a second freight different from the first freight and to transfer the second freight, a buffer part disposed between the automated loading part and the transporting part, and a replacement part configured to replace the first freight and the second freight together with the buffer part. Therefore, damage to freight may be prevented, and a replacement speed between different freights may be increased.

### CROSS REFERENCE TO RELATED APPLICATION

The present application claims priority to Korean Patent Application No. 10-2023-0093960, filed Jul. 19, 2023, the entire contents of which are incorporated herein for all purposes by this reference.

### BACKGROUND OF THE INVENTION

### Field of the Invention

The present disclosure relates to a freight replacement apparatus and a freight replacement method.

### Description of the Related Art

Conventionally, when a worker moves freight to a warehouse or a depository or when the worker moves freight from a warehouse or a depository to a desired destination, the moving operation is performed by manually loading the freight on a cart. Since such a loading operation is performed repeatedly and the freight weight is considerable, the worker may be exposed to an accident or a harmful substance during the manual operation, and the logistics process may be delayed due to damage to the freight and to an error in freight information.

To this end, recently, a system capable of constructing various types of logistics processes has been developed in order to maximize profits and to increase efficiency. As interest and necessity of logistics technology increases, research in related fields such as logistics transport, automation, efficiency, eco-friendly technology, unmanned technology, and so on are actively being conducted.

### DOCUMENT OF RELATED ART

(Patent Document 1) KR 2022-0066714 A

### SUMMARY OF THE INVENTION

According to an aspect of the present disclosure, there is provided a freight replacement apparatus and a freight replacement method that are capable of preventing damage to freight.

In addition, according to another aspect of the present disclosure, there is provided a freight replacement apparatus and a freight replacement method that are capable of increasing a replacement speed between different freights.

According to the present disclosure, there is provided a freight replacement apparatus including: an automated loading part configured to load thereon a first freight and move to a designated position; a transporting part configured to load thereon a second freight different from the first freight and transfer the second freight; a buffer part disposed between the automated loading part and the transporting part; and a replacement part configured to replace the first freight and the second freight together with the buffer part.

According to an embodiment, the replacement part may transport the first freight and may temporarily load the first freight on the buffer part, may transport the second freight and may load the second freight on the automated loading part, and may load the first freight loaded on the buffer part on the transporting part. Furthermore, the buffer part may measure the weight of the first freight when the first freight is loaded on the buffer part.

According to an embodiment, the automated loading part may move the second freight loaded on the automated loading part to an outside of the replacement part, and the transporting part may transport the first freight loaded on the transporting part to the outside of the replacement part.

According to an embodiment, the freight replacement apparatus may further include a control unit configured to determine whether the measured weight falls within a preset value range, and the control unit may generate an alarm when the control unit determines that the measured weight does not fall within the preset value range.

According to an embodiment, the replacement part may include: a plurality of support frames disposed vertically on positions spaced apart from each other; a horizontal frame mounted on the support frames; a guide rail mounted on both left and right sides of the horizontal frame along a longitudinal direction of the horizontal frame; and a freight transfer unit configured to be driven forward and backward on the guide rail and to be raised and lowered in a vertical direction perpendicular to the longitudinal direction.

According to an embodiment, the freight transfer unit may include: a driving mechanism configured to transport freight forward and backward; a lifting mechanism configured to move the freight upward and downward; a rotation mechanism configured to change a loading direction of the freight; and a holding mechanism configured to hold the freight.

According to an embodiment, the first freight may be a wound bobbin on which a material is wound and the second freight may be an empty bobbin which the material is absent, or the first freight may be the empty bobbin and the second freight may be the wound bobbin.

According to an embodiment, the material may include an electrode material of a battery.

According to the present disclosure, there is provided a freight replacement method including: loading a first freight on an automated loading part and moving the automated loading part to a designated position; loading a second freight different from the first freight on a transporting part and transporting the second freight; placing a buffer part between the automated loading part and the transporting part; and replacing the first freight and the second freight by a replacement part together with the buffer part.

According to an embodiment, the replacing the first freight and the second freight may include: transporting the first freight and temporarily loading the first freight on the buffer part by the replacement part; measuring a weight of the first freight by the buffer part; transporting the second freight and loading the second freight on the automated loading part by the replacement part; and loading the first freight loaded on the buffer part on the transporting part by the replacement part.

According to an embodiment, after the replacing the first freight and the second freight, the freight replacement method may further include: moving the second freight loaded on the automated loading part to an outside of the replacement part by the automated loading part; and transporting the first freight loaded on the transporting part to the outside of the replacement part by the transporting part.

According to an embodiment, the replacing the first freight and the second freight may further include determining, by a control unit, whether the measured weight falls within a preset value range and generating an alarm when the control unit determines that the measured weight does not fall within the preset value range.

According to an embodiment, the first freight may be a wound bobbin on which a material is wound and the second freight may be an empty bobbin which the material is absent, or the first freight may be the empty bobbin and the second freight may be the wound bobbin.

According to an embodiment, the material may include an electrode material of a battery.

According to an embodiment of the present disclosure, damage to freight may be prevented.

According to an embodiment of the present disclosure, a replacement speed between different freights may be increased.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is an overall schematic view illustrating a process of inputting and discharging freight through each process facility and each warehouse according to an embodiment;

FIG. 2 is a perspective view schematically illustrating a freight replacement apparatus according to an embodiment;

FIG. 3 is a block diagram illustrating a control unit of the freight replacement apparatus according to an embodiment;

FIG. 4 is a perspective view schematically illustrating a replacement part of the freight replacement apparatus according to an embodiment;

FIG. 5 is a perspective view schematically illustrating a freight transfer unit of the replacement part according to an embodiment; and

FIG. 6 is a flowchart illustrating a freight replacement method according to an embodiment.

### DETAILED DESCRIPTION OF THE INVENTION

Objectives, advantages, and features of the present disclosure will be more apparent from the following detailed description and exemplary embodiments taken in connection with the accompanying drawings, but the present disclosure is not limited thereto. Furthermore, in the description of the present disclosure, it is to be noted that, when known techniques related to the present disclosure may make the gist of the present disclosure unclear, a detailed description thereof will be omitted.

In adding reference numerals to components throughout the drawings, it is to be noted that like or similar reference numerals designate like or similar components even though the components are illustrated in different drawings.

The terms used in the present disclosure are used to describe an embodiment, and are not intended to limit the present disclosure. Singular expressions include plural expressions unless the context clearly indicates otherwise.

The drawings may be exaggerated or shown schematically for description of an embodiment. In the present disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

The terms “one”, “other”, “another”, “first”, “second”, and so on are used to differentiate one constituent element from another constituent element, and these constituent elements should not be limited by these terms.

It should be understood that, when terms representing directions such as upwards, downwards, left, right, X-axis, Y-axis, Z-axis, and so on are used in the specification, these terms are merely for convenience of description, and such directions may be expressed differently from those represented by the terms, in accordance with the viewing position of an observer or the position at which an object is disposed.

Embodiments described in the present disclosure and the accompanying drawings are not intended to limit the present disclosure to the particular forms disclosed. The present disclosure should be understood to cover all modifications, equivalents, and/or alternatives of the embodiments.

Hereinafter, the present disclosure will be described in detail with reference to the accompanying drawings. However, those skilled in the art will appreciate that such embodiments are provided to further understand the spirit of the present disclosure and do not limit subject matters to be protected as disclosed in the detailed description and appended claims.

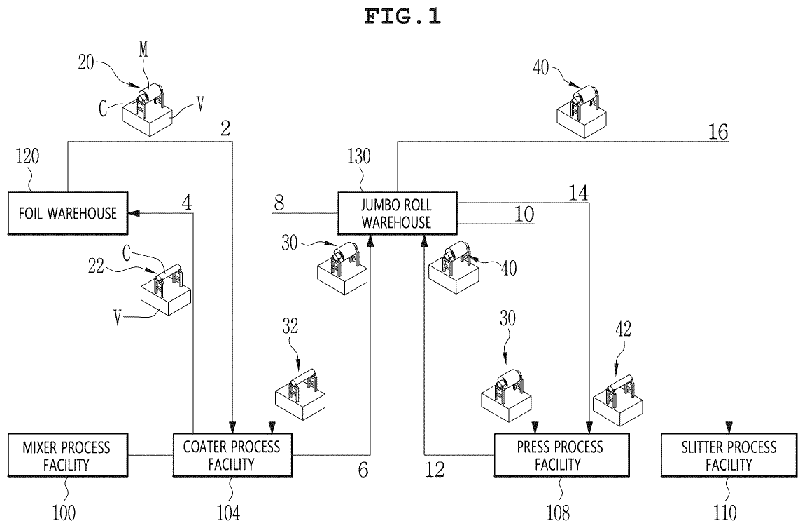

FIG. 1 is an overall schematic view illustrating a process of inputting and discharging freight through each process facility and each warehouse according to an embodiment. Here, the freight may be defined as wound bobbins 20, 30, and 40 on which a material M is wound in a roll shape on a core shaft C, or may be defined as empty bobbins 22, 32, and 42 having only the core shaft C. In addition, here, the material M is described as an electrode material of a battery, but this is only an example. Therefore, as long as the material M does not depart from the scope of the present disclosure, material M can be replaced with any material that can be used in other industrial sites or other production lines.

Referring to FIG. 1, at least one process facility required for manufacturing an electrode of a battery, and at least one warehouse (or a storage) capable of automatically inputting and discharging such an electrode material may be located on site. The wound bobbins 20, 30, and 40 or the empty bobbins 22, 32, and 42 may be moved from the process facility to the warehouse by an automated loading part V, and may be moved from the warehouse to the process facility by the automated loading part V. The automated loading part V may be a device configured to be driven accurately and safely after the wound bobbins 20, 30, and 40 or the empty bobbins 22, 32, and 42 are loaded on the automated loading part V, thereby moving the corresponding bobbins. For example, the automated loading part V may include an Automated Guided Vehicle (AGV) and so on.

In the electrode manufacturing of the battery, the process facility may include, for example, a mixer process facility 100, a coater process facility 104, a press process facility 108, a slitter process facility 110, and so on.

The mixer process facility 100 is capable of performing mixing by inputting a conductive agent and a binder into an active material.

The coater process facility 104 may apply a slurry in which the active material, the conductive agent, and the binder are mixed with each other and which is supplied from the mixer process facility 100 to the electrode material.

The press process facility 108 is capable of performing compressing such that the electrode material and the active material are securely attached to each other.

The slitter process facility 110 may adjust a size of an electrode for a battery assembly process that will be performed later.

Meanwhile, the warehouse may include a foil warehouse 120 and a jumbo roll warehouse 130. The foil warehouse 120 may store and contain foil-wound bobbin 20 comprising the electrode material, such as a foil supplied from the outside. In addition, in the foil warehouse 120, the foilless empty bobbin 22 may be replaced with the foil-wound bobbin 20.

The jumbo roll warehouse 130 may store and contain the electrode materials supplied from the coater process facility 104 and the press process facility 108. For example, the jumbo roll warehouse 130 may store and contain first and second jumbo rolls-wound bobbins 30 and 40 including the electrode material in which the coater process is completed and the electrode material in which the press process is completed. In addition, in the jumbo roll warehouse 130, the first and second jumbo rolls-wound bobbins 30 and 40 may be replaced with first and second jumbo rolls-empty bobbins 32 and 42.

A process in which the wound bobbins 20, 30, and 40 or the empty bobbins 22, 32, and 42 are automatically input and discharged through each process facility and each warehouse is as follows:

1) As illustrated by the arrow 2, the foil-wound bobbin 20 in the foil warehouse 120 may be loaded on the automated loading part V, and then the automated loading part V may be moved to the coater process facility 104. As illustrated by the arrow 4, the automated loading part V may move the foilless empty bobbin 22 from the coater process facility 104 to the foil warehouse 120. In the foil warehouse 120, the foilless empty bobbin 22 may be replaced with the foil-wound bobbin 20. In this manner, the processes according to the arrow 2 and the arrow 4 may be performed repeatedly.

2) As illustrated by the arrow 6, the first jumbo roll-wound bobbin 30 including the electrode material in which the coater process is completed in the coater process facility 104 may be loaded on the automated loading part V, and then the automated loading part V may be moved to the jumbo roll warehouse 130. In the jumbo roll warehouse 130, the first jumbo roll-wound bobbin 30 is replaced with the first jumbo roll-empty bobbin 32, and the first jumbo roll-wound bobbin 30 may be stored in the jumbo roll warehouse 130. As illustrated by the arrow 8, the first jumbo roll-empty bobbin 32 may be loaded on the automated loading part V, and then the automated loading part V may be moved to the coater process facility 104. In this manner, the processes according to the arrow 6 and the arrow 8 may be performed repeatedly.

3) As illustrated by the arrow 10, the first jumbo roll-wound bobbin 30 in the jumbo roll warehouse 130 may be loaded on the automated loading part V, and then the automated loading part V may be moved to the press process facility 108. As illustrated by the arrow 12, the second jumbo roll-wound bobbin 40 including the electrode material in which the press process is completed in the press process facility 108 may be loaded on the automated loading part V, and then the automated loading part V may be moved to the jumbo roll warehouse 130. In the jumbo roll warehouse 130, the second jumbo roll-wound bobbin 40 may be replaced with the second jumbo roll-empty bobbin 42, and the second jumbo roll-wound bobbin 40 may be stored in the jumbo roll warehouse 130. As illustrated by the arrow 14, the second jumbo roll-empty bobbin 42 may be loaded on the automated loading part V, and then the automated loading part V may be moved to the press process facility 108. In this manner, the processes according to the arrow 10, the arrow 12, and the arrow 14 may be performed repeatedly.

4) As illustrated by the arrow 16, the second jumbo roll-wound bobbin 40 stored and contained in the jumbo roll warehouse 130 may be loaded on the automated loading part V, and then the automated loading part V may be moved to the slitter process facility 110. The electrode material in which the slitter process is completed in the slitter process facility 110 may be moved to a battery assembly process facility (not illustrated) for the battery assembly process.

The processes described above is only an example for a summary description of the present disclosure, and the present disclosure is not limited thereto. Furthermore, the movement of the wound bobbins 20, 30, and 40 or the empty bobbins 22, 32, and 42 by the automated loading part V may be changed according to the setting location of each process facility and each warehouse, as long as it does not exceed the scope of the present disclosure.

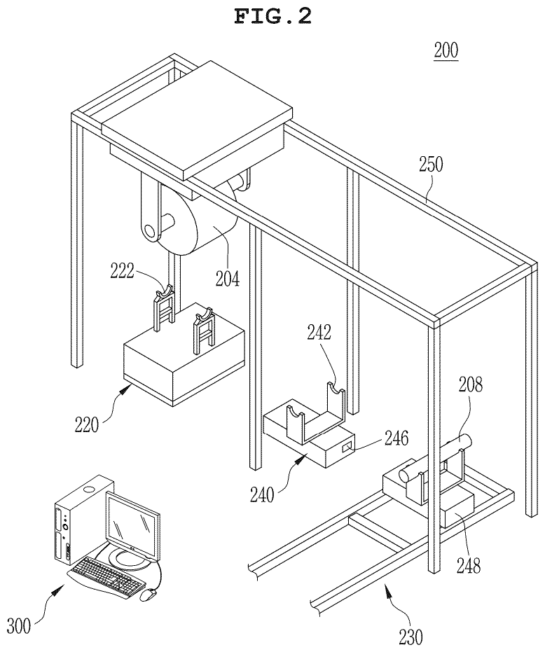

FIG. 2 is a perspective view schematically illustrating a freight replacement apparatus according to an embodiment.

A freight replacement apparatus 200 may be disposed in a warehouse and may replace different freights with each other. The warehouse is a place where the freights are replaced with each other. For example, as illustrated in FIG. 1, the warehouse may include the foil warehouse 120 or the jumbo roll warehouse 130.

The freight replacement apparatus 200 may include an automated loading part 220 configured to load thereon a first freight 204 and to move the first freight 204 to a designated position, a transporting part 230 configured to load thereon a second freight 208 different from the first freight 204 and to transport the second freight 208, a buffer part 240 disposed between the automated loading part 220 and the transporting part 230, a replacement part 250 configured to replace the first freight 204 and the second freight 208 together with the buffer part 240, and a control unit 300 configured to control the automated loading part 220, the transporting part 230, the buffer part 240, and the replacement part 250. Here, the first freight 204 may be a wound bobbin on which a material is wound, and the second freight 208 may be an empty bobbin which the material is absent. Alternatively, the first freight 204 may be the empty bobbin which the material is absent, and the second freight 208 may be the wound bobbin on which the material is wound. Such a material may include an electrode material of a battery.

As illustrated in FIG. 1, the automated loading part 220 may be a device on which freight such as a wound bobbin or an empty bobbin is mounted and which is configured to move the corresponding freight by being accurately and safely driven.

The automated loading part 220 may include a freight holder 222 on an upper plate of the automated loading part 220 so that the first freight 204 is capable of being loaded on the automated loading part 220. The automated loading part 220 may be moved to a predetermined path according to a setting of the worker. For example, the automated loading part 220 may be moved into the replacement part 250. In addition, the automated loading part 220 may stop or wait at the designated position so that the first freight 204 and the second freight 208 are capable of being rapidly replaced. For example, the automated loading part 220 may supply the first freight 204 to the replacement part 250 and may receive the second freight 208 from the replacement part 250 without being moved from the designated position. After the first freight 204 and the second freight 208 are replaced, the automated loading part 220 may load thereon the second freight 208, and then the automated loading part 220 may be moved outside the replacement part 250.

The second freight 208 may be loaded on a transporting device 248, and then the transporting part 230 may move the second freight 208 to the replacement part 250. The transporting part 230 may include a belt conveyor configured to load freight on a belt and to transport the freight by circulating the belt formed of such as rubber, a fabric, a wire mesh, a steel sheet, and so on, and may include a roller conveyor configured to load freight on a roller and to transport the freight by using the roller, but there is no limitation and various transporting apparatuses capable of transporting freight may be included. Such a transporting apparatus may include various transporting machines that directly load freight.

A first side portion of the transporting part 230 may be positioned inside the replacement part 250, and a second side portion of the transporting part 230 may be positioned outside the replacement part 250. Since the second side portion of the transporting part 230 does not interfere with the replacement part 250, a stacker crane (not illustrated) can approach the second side portion of the transporting part 230. Accordingly, the transporting part 230 may transport freight supplied from the replacement part 250 and then may transport the freight to the stacker crane, or may transport freight supplied from the stacker crane and then may transfer the freight to the replacement part 250. For example, the transporting part 230 may transport the first freight 204 supplied from the replacement part 250 and then may transfer the first freight 204 to the stacker crane, and may transport the second freight 208 supplied from the stacker crane and then may transfer the second freight 208 to the replacement part 250.

The stacker crane may input freight to the transporting part 230, or may discharge freight from the transporting part 230. For example, the stacker crane may input the second freight 208 to the transporting part 230 in order to supply the second freight 208 loaded on a shelf or a rack in the warehouse to the replacement part 250. In addition, in order to store the first freight 204 supplied from the replacement part 250 on the shelf or the rack in the warehouse, the stacker crane may discharge the first freight 204 from the transporting part 230.

The buffer part 240 may include a buffer freight holder 242 on an upper plate of the buffer part 240 so that the first freight 204 is temporarily loaded on the buffer freight holder 242. In addition, the buffer part 240 may be positioned in the replacement part 250. Particularly, the buffer part 240 may be positioned between the automated loading part 220 and the transporting part 230. Furthermore, the buffer part 240 may be positioned between the automated loading part 220 and at least a portion of the transporting part 230 (for example, the first side portion of the transporting part 230). Therefore, the buffer part 240, the automated loading part 220, and at least a portion of the transporting part 230 may be aligned in a line with each other in the replacement portion 250.

The buffer part 240 is positioned between the automated loading part 220 and the transporting part 230. Therefore, in the replacement part 250, an operation movement line for replacing the first freight 204 and the second freight 208 may be significantly reduced. The reduction in the operation movement line may increase convenience of the work by increasing a replacement speed between different freights while maximally preventing damage to the freights, and may also significantly reduce complexity of the automation.

In addition, the buffer part 240 may include a sensor 246 capable of measuring the weight of the first freight 204 when the first freight 204 is loaded on the buffer part 240.

Data on the weight value measured by the sensor 246 may be transmitted to the control unit 300.

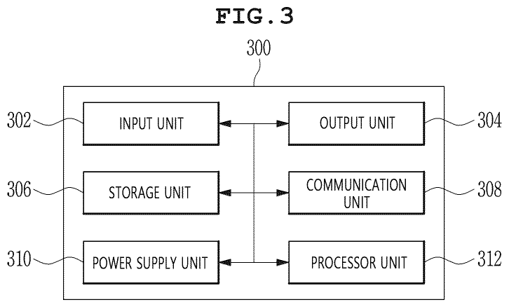

FIG. 3 is a block diagram illustrating the control unit of the freight replacement apparatus according to an embodiment.

Referring to FIG. 3 together with FIG. 2, as described above, the control unit 300 is connected to the automated loading part 220, the transporting part 230, the buffer part 240, and the replacement part 250 in a wired manner or a wireless manner, and may individually or comprehensively control each component part.

The control unit 300 may include, a Central Processing Unit (CPU), a Graphics Processing Unit (GPU), various dedicated Artificial Intelligences (AIs), a computing chip, various computation units that run a machine learning model algorithm, a Digital Signal Processor (DSP), any appropriate processor, a controller, a microcontroller, and so on, but there is no limitation and the control unit 300 may be a digital computer in various types.

For example, the control unit 300 may be a laptop computer, a desktop computer, a workbench, a personal digital assistant, a server, a blade server, a mainframe computer, or other appropriate computers. In addition, the control unit 300 may be various forms of mobile apparatuses such as a personal digital assistant, a cellular phone, a smart phone, a wearable device, and other similar computing apparatuses.

Particularly, the control unit 300 may determine whether the weight of the freight measured in the buffer part 240 falls within a preset value range.

To this end, the control unit 300 may include an input unit 302, an output unit 304, a storage unit 306, a communication unit 308, a power supply unit 310, and a processor unit 312.

The input unit 302 allows the worker to input a command or data, and may include a hard key, a soft key, a touch pad, a mouse, and so on. In addition, the input unit 302 may have a form of a touch screen along with the output unit 304 described below. Accordingly, data for determining whether the freight temporarily loaded on the buffer part 240 is normal freight may be input by the worker in advance in the input unit 302.

The output unit 304 is configured to output the input and received data, and may include a light emitting diode, a display, a speaker, and so on. For example, the output unit 304 may generate an alarm when there is an abnormality in freight temporarily loaded on the buffer part 240.

The storage unit 306 is configured to store all data for managing the operation of the freight replacement apparatus 200. For example, the data may include a program code or an executable command, a data structure, a program module, other data, and so on, and the storage unit 306 may include a hard disc, a magnetic disc, an optical disc, and so on.

The communication unit 308 may communicate with the automated loading part 220, the transporting part 230, the buffer part 240, and the replacement part 250 in a wired manner or a wireless manner, thereby being capable of transmitting and receiving data with each of the components. Particularly, the communication unit 308 may transmit a freight measurement command to the buffer part 240 so as to measure the weight of the loaded freight, and may receive data on the measured freight weight.

The power supply unit 310 may supply power to each component of the control unit 300 by using an external power source that uses an external power grid or an external electric power source or by using an internal power source such as a built-in rechargeable battery.

The processor unit 312 may be executed by reading a program code stored in the storage unit 306. Accordingly, the processor unit 312 may manage the driving and the operation of the automated loading part 220, the transporting part 230, and the replacement part 250. For example, the processor unit 312 may manage the number of movements and the movement speed of the automated loading part 220, may adjust the driving time and the driving speed of the transporting part 230 in consideration of when the automated loading part 220 enters the replacement part 250, and may control the operation time and the operation speed of the replacement part 250.

Particularly, the processor unit 312 may determine whether the freight weight value received by the communication unit 308 falls within the preset value range stored in the storage unit 306.

When the freight weight value falls within the preset value range, the processor unit 312 may notify the worker through the output unit 304 that there is no abnormality in the freight loaded on the buffer part 240, and then the subsequent process may be performed continuously.

When the freight weight value does not fall within the preset value range, the processor unit 312 may notify the worker through the output unit 304 that there is an abnormality in the freight loaded on the buffer part 240, and may stop the operation of the transporting part 230 and the replacement unit 250.

Therefore, the processor unit 312 may determine whether the freight loaded on the buffer part 240 is an empty bobbin or a wound bobbin. Furthermore, by notifying the worker of the determined result, the worker may easily check the process that is currently in progress. For example, when the replacement part 250 replaces the first freight 204 supplied from the automated loading part 220 and the second freight 208 transported from the transporting part 230, the buffer part 240 is required to load the first freight 204 from the replacement part 250, so that the worker may know that the current process is in a situation in which the first freight 204 is input and the second freight 208 is discharged.

In addition, when the first freight 204 loaded on the buffer part 240 is a wound bobbin, the processor unit 312 may measure the weight of the wound bobbin through the buffer part 240, and the processor unit 312 may determine whether there is an abnormality in the wound bobbin. Therefore, since the processor unit 312 immediately notifies the worker of the determined result, the worker may check whether the current wound bobbin is a normal wound bobbin or an abnormal wound bobbin. In other words, during the process of freight replacement, the worker is capable of immediately recognizing the status of the freight, so that an information error about the freight status may be prevented.

The processor unit 312 may include a device capable of processing information, such as a Central Processing Unit (CPU), a Programmable Logic Circuit (PLC), a Field Programmable Gate Array (FPGA), an Application Specific Integrated Circuit (ASIC), a System On Chip (SOC), a Complex Programmable Logic Device (CPLD), and so on.

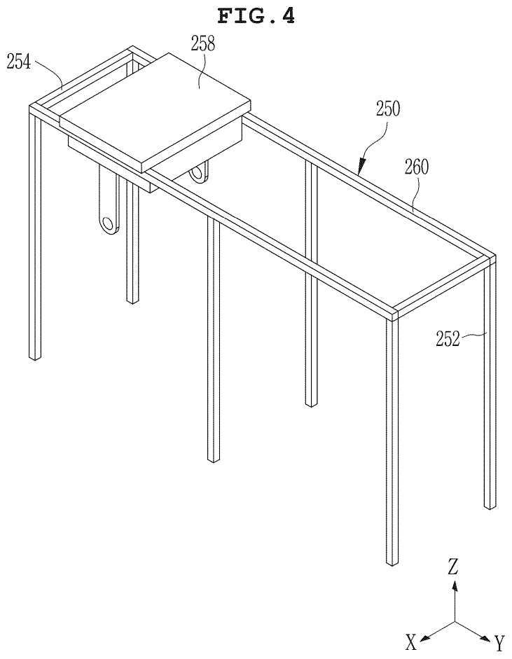

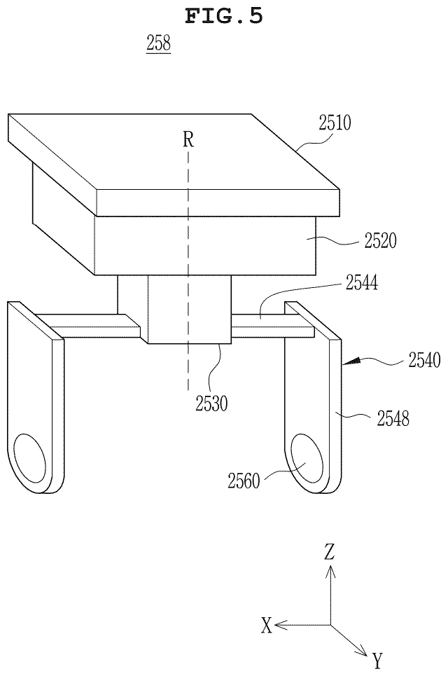

FIG. 4 is a perspective view schematically illustrating the replacement part of the freight replacement apparatus according to an embodiment. FIG. 5 is a perspective view schematically illustrating a freight transfer unit of the replacement part according to an embodiment. Hereinafter, the present disclosure will be described with reference to FIG. 4 and FIG. 5.

The replacement part 250 may include a plurality of support frames 252 disposed vertically on positions spaced apart from each other, a horizontal frame 254 mounted on the support frames 252, a guide rail 260 mounted on both left and right sides of the horizontal frame 254 along a longitudinal direction (a Y-axis direction) of the horizontal frame 254, and a freight transfer unit 258 configured to be driven forward and backward on the guide rail 260 and to be lifted in a vertical direction (a Z-axis direction) perpendicular to the longitudinal direction.

For example, referring to FIG. 2 again, in order to replace the first freight 204 and the second freight 208, the freight transfer unit 258 is capable of being rotated, capable of being driven forward and backward, and capable of being raised and lowered. Therefore, the freight transfer unit 258 is capable of moving each of the first freight 204 and the second freight 208 upward, and is capable of moving each of the first freight 204 and the second freight 208 downward to the desired destination.

To this end, as illustrated in FIG. 5, the freight transfer unit 258 may include a driving mechanism 2510 configured to transfer freight (for example, the first freight 204 or the second freight 208 shown in FIG. 2) forward and backward, a lifting mechanism 2520 configured to move the freight upward and downward, a rotation mechanism 2530 configured to change a loading direction of the freight, and a holding mechanism 2540 configured to hold the freight.

Specifically, the driving mechanism 2510 may be mounted on the guide rail 260 such that the driving mechanism 2510 is capable of being driven forward and backward. Therefore, the driving mechanism 2510 is capable of performing a driving movement in the direction (the Y-axis direction) parallel to the horizontal frame 254 along the guide rail 310 by an operation of a driving module (not illustrated). The driving module may be mounted on at least one of the driving mechanism 2510, the lifting mechanism 2520, and the rotation mechanism 2530.

By the operation of the driving module, the lifting mechanism 2520 may perform a lifting movement upward and downward toward the automated loading part 220, the buffer part 240, or the transporting part 230 (see FIG. 2) in the direction (the Z-axis direction) parallel to the support frame 252. The rotation mechanism 2530 may be rotated with respect to the driving mechanism 2510 around a rotation shaft R by the operation of the driving module. Here, the rotation shaft R is disposed at a center of the driving mechanism 2510 and is formed in the direction (the Z-axis direction) parallel to the support frame 252. Particularly, the rotation mechanism 2530 may change the loading direction of the freight. For example, referring to FIG. 5 together with FIG. 2, when the freight (freight loaded in the Y-axis direction) loading direction of the automated loading part 220 and the freight (freight loaded in the X-axis direction) loading direction of the transporting part 230 are different from each other and the second freight 208 is required to be loaded on the automated loading part 220, the rotation mechanism 2530 may be rotated by 90 degrees so that the second freight 208 is capable of being loaded on the automated loading part 220.

The holding mechanism 2540 may include a holder moving device 2544 which is mounted on both sides of the rotation mechanism 2530 and which is configured to be reciprocated in the rectilinear direction (the X-axis direction), and may include a pair of holding arms 2548 which is mounted on each end portion of the holder moving device 2544 and which is configured to hold the freight according to a reciprocating movement of the holder moving device 2544. A cylinder (not illustrated) for the reciprocating movement of the holder moving device 2544 and a driving motor (not illustrated) that operates the cylinder may be mounted inside the rotation mechanism 2530. An opening 2560 may be formed on each lower portion of the pair of holding arms 2548 such that a core shaft of the first freight 204 or the second freight 208 is capable of being fitted to each opening 2560. Alternatively, instead of the opening 2560, a gripper may be formed on each lower portion of the pair of holding arms 2548 such that the core shaft of the freight is capable of being gripped or held.

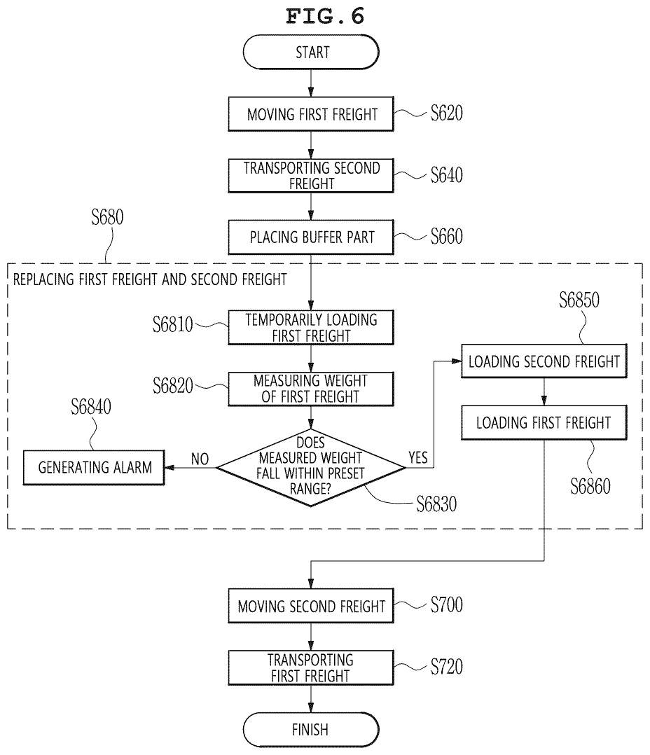

FIG. 6 is a flowchart illustrating a freight replacement method according to an embodiment.

A freight replacement method may include a first movement process S620, a first transportation process S640, a placement process S660, and a replacement process S680.

Firstly, in the first movement process S620, the automated loading part 220 may load the first freight 204 and move to a designated position. For example, the automated loading part 220 may stop or wait at the designated position in the replacement part 250 in order to supply the first freight 204 to the replacement part 250 and to receive the second freight 208 from the replacement part 250.

In the first transportation process S640, the transporting part 230 may load the second freight 208 different from the first freight 204 and then may transport the second freight 208. The second freight 208 may be a freight supplied from the stacker crane.

In the placement process S660, the buffer part 240 may be disposed in the replacement part 250. Particularly, the buffer part 240 may be disposed between the automated loading part 220 and the transporting part 230.

In FIG. 6, it is illustrated that the freight replacement method is performed in the order of the first movement process S620, the first transportation process S640, and the placement process S660. However, this order is only an example and the freight replacement method does not proceed in the specific order. For example, at least two of the first movement process S620, the first transportation process S640, and the placement process S660 may be started simultaneously, and the placement process S660 may be started before the first movement process S620 or the first transportation process S640.

In the replacement process S680, the replacement part 250 may replace the first freight 204 and the second freight 208 together with the buffer part 240. The replacement part 250 may include the freight transfer unit 258 so that freights different from each other are capable of being replaced in the replacement part 250. The replacement part 250 and the freight transfer unit 258 that is capable of being moved on an upper portion of the replacement part 250 are described in detail in FIG. 5, so that a detailed description of the replacement part 250 and the freight transfer unit 258 will be omitted.

Specifically, the replacement process S680 may include a temporary loading process S6810, a weight measurement process S6820, a determination process S6830, an alarm process S6840, a first loading process S6850, and a second loading process S6860.

In the temporary loading process S6810, the replacement part 250 holds the first freight 204 loaded on the automated loading part 220 and transfers the first freight 204 to the buffer part 240, so that the first freight 204 may be temporarily loaded on the buffer part 240.

In the weight measurement process S6820, the buffer part 240 may measure the weight of the first freight 204 by using the sensor 246.

In the determination process S6830, the control unit 300 may receive data on the weight of the measured first freight 204, and may determine whether such weight falls within the preset value range. When the control unit 300 determines that the measured weight does not fall within the preset value range, the method proceeds to the alarm process S6840, and the control unit 300 may generate an alarm and may stop the operation of the replacement part 250.

In the determination process S6830, when the control unit 300 determines that the measured weight falls within the preset value range, the method may proceed to the first loading process S6850.

In the first loading process S6850, the replacement part 250 holds the second freight 208 transported in the first transportation process S640 and transfers the second freight 208 to the automated loading part 220, so that the second freight 208 may be loaded on the automated loading part 220.

In the second loading process S6860, the replacement part 250 holds the first freight 204 loaded on the buffer part 240 and transfers the first freight 204 to the transporting part 230, so that the first freight 204 may be loaded on the transporting part 230.

The freight replacement method may further include a second movement process S700 and a second transportation process S720 that are performed after the replacement process S680.

In the second movement process S700, the automated loading part 220 may move the second freight 208 loaded in the first loading process S6850 to the outside of the replacement part 250 for the subsequent process. In the second transportation process S720, in order to deliver the first freight 204 to the stacker crane, the transporting part 230 may transport the first freight 204 loaded in the second loading process S6860 to the outside of the replacement part 250. In FIG. 6, it is illustrated that the freight replacement method is performed in the order of the second movement process S700 and the second transportation process S720. However, this order is only an example and the freight replacement method does not proceed in the specific order. For example, the second movement process S700 and the second transportation process S720 may be performed simultaneously, or the second transportation process S720 may be started before the second movement process S700.

In the freight replacement method described above, when the first freight 204 is an empty bobbin and the second freight 208 is a wound bobbin, the replacement procedure (S620 to S720) according to the freight replacement method may be performed, for example, in the foil warehouse 120 in which the foilless empty bobbin 22 is replaced with the foil-wound bobbin 20 as illustrated in FIG. 1. In addition, when the first freight 204 is a wound bobbin and the second freight 208 is an empty bobbin, the replacement procedure (S620 to S720) according to the freight replacement method may be performed, for example, in the jumbo roll warehouse 130 in which the first and second jumbo rolls-wound bobbins 30 and 40 are replaced with the first and second jumbo rolls-empty bobbins 32 and 42 as illustrated in FIG. 1.

The contents described above are only examples of applying the principles of the present disclosure, and other configurations may be further included within the scope of the present disclosure.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the present disclosure.

Furthermore, simple changes and modifications of the present disclosure are appreciated as included in the scope and spirit of the present disclosure, and the protection scope of the present disclosure will be defined by the claims.

What is claimed is:

1. A freight replacement apparatus comprising:
an automated loading part configured to load thereon a first freight and move to a designated position;
a transporting part configured to load thereon a second freight different from the first freight and transfer the second freight;
a buffer part disposed between the automated loading part and the transporting part; and
a replacement part configured to replace the first freight and the second freight together with the buffer part.

2. The freight replacement apparatus of claim 1, wherein the replacement part transports the first freight and temporarily loads the first freight on the buffer part, transports the second freight and loads the second freight on the automated loading part, and loads the first freight loaded on the buffer part on the transporting part, and
the buffer part measures a weight of the first freight when the first freight is loaded on the buffer part.

3. The freight replacement apparatus of claim 2, wherein the automated loading part moves the second freight loaded on the automated loading part to an outside of the replacement part, and the transporting part transports the first freight loaded on the transporting part to the outside of the replacement part.

4. The freight replacement apparatus of claim 2, further comprising a control unit configured to determine whether the measured weight falls within a preset value range,
wherein the control unit generates an alarm when the control unit determines that the measured weight does not fall within the preset value range.

5. The freight replacement apparatus of claim 1, wherein the replacement part comprises:
a plurality of support frames disposed vertically on positions spaced apart from each other,
a horizontal frame mounted on the support frames;
a guide rail mounted on both left and right sides of the horizontal frame along a longitudinal direction of the horizontal frame; and
a freight transfer unit configured to be driven forward and backward on the guide rail and to be raised and lowered in a vertical direction perpendicular to the longitudinal direction.

6. The freight replacement apparatus of claim 5, wherein the freight transfer unit comprises:
a driving mechanism configured to transport freight forward and backward;
a lifting mechanism configured to move the freight upward and downward;
a rotation mechanism configured to change a loading direction of the freight; and
a holding mechanism configured to hold the freight.

7. The freight replacement apparatus of claim 1, wherein the first freight is a wound bobbin on which a material is wound, and the second freight is an empty bobbin which the material is absent, or
the first freight is the empty bobbin, and the second freight is the wound bobbin.

8. The freight replacement apparatus of claim 7, wherein the material comprises an electrode material of a battery.

9. A freight replacement method comprising:
loading a first freight on an automated loading part and moving the automated loading part to a designated position;
loading a second freight different from the first freight on a transporting part and transporting the second freight;
placing a buffer part between the automated loading part and the transporting part; and
replacing the first freight and the second freight by a replacement part together with the buffer part.

10. The freight replacement method of claim 9, wherein the replacing the first freight and the second freight comprises:
transporting the first freight and temporarily loading the first freight on the buffer part by the replacement part;
measuring a weight of the first freight by the buffer part;
transporting the second freight and loading the second freight on the automated loading part by the replacement part; and
loading the first freight loaded on the buffer part on the transporting part by the replacement part.

11. The freight replacement method of claim 10, wherein, after the replacing the first freight and the second freight, the freight replacement method further comprises:
moving the second freight loaded on the automated loading part to an outside of the replacement part by the automated loading part; and
transporting the first freight loaded on the transporting part to the outside of the replacement part by the transporting part.

12. The freight replacement method of claim 10, wherein the replacing the first freight and the second freight further comprises determining, by a control unit, whether the measured weight falls within a preset value range and generating an alarm when the control unit determines that the measured weight does not fall within the preset value range.

13. The freight replacement method of claim 9, wherein the first freight is a wound bobbin on which a material is wound, and the second freight is an empty bobbin which the material is absent, or
the first freight is the empty bobbin, and the second freight is the wound bobbin.

14. The freight replacement method of claim 13, wherein the material comprises an electrode material of a battery.
